(19) United States
(12) Patent Application Publication
(10) Pub. No.: US 2026/0185340 A1
(43) Pub. Date: Jul. 2, 2026

(54) SUCTION AND ODOUR EVACUATION SYSTEM WITH PASSIVE AND CONTINUOUS HYDRAULIC SEALING

(71) Applicant: 9123-7826 QUÉBEC INC., Sherbrooke (CA)

(72) Inventors: Pascale LAROCQUE, Sherbrooke (CA); Donald TREMBLAY, Drummondville (CA); Steve LUSSIER, Sherbrooke (CA); Augustin ARCHAMBAULT, Stoke (CA); Benjamin PAQUET, Victoriaville (CA)

(21) Appl. No.: 19/131,717

(22) PCT Filed: Nov. 24, 2023
(86) PCT No.: PCT/CA2023/051574

§ 371 Date: May 21, 2025

Related U.S. Application Data
(60) Provisional application No. 63/384,984, filed on Nov. 25, 2022.

(51) Int. Cl. E03D 9/052; C05F 17/979

(52) U.S. Cl. CPC E03D 9/052; C05F 17/979

(57) ABSTRACT

The present invention relates to a fully integrated equipment installed inside a toilet tank for the extraction and evacuation of odours as well as contaminated air that is usually found in a toilet, and continuously guarantees a passive water trap to block the return of odours from the sewer connected to the sanitary appliance.

### FIELD OF THE INVENTION

The present invention relates to sanitary wares, more particularly to a system for removing odours from a toilet bowl and evacuation to a sewer line.

### BACKGROUND OF THE INVENTION

In recent years, there has been a growing trend towards improving the quality of hygiene and lifestyle at all levels. This desire for improvement is reflected in all aspects of daily life and more particularly in the bathrooms that are nowadays centrepieces of homes and buildings. These bathrooms, which are visited several times a day, must provide the user with the most pleasant, comfortable and health-safe experience. The use of sanitary ware such as toilets, urinals, and bidets, for natural needs and others, sometimes produce odours that are annoying, repulsive, or even unbearable, and that lead or accentuate, for some people, to health problems.

To solve the problem associated with the production of odours caused by the use of sanitary ware such as toilets during visits to the bathroom, different solutions are used and offer very unsatisfactory results in terms of the elimination of odours and protection of the health of users.

The most common method to solve this odour problem is to use a ceiling fan that draws air and odours from the bathroom to a duct that carries and evacuates airflow into the atmosphere. This energy-intensive method only increases the problem, as the fan pulls the air filled with bad odours upwards, passing it under the noses of the users, scattering it throughout the room and then sending it into the atmosphere after several minutes. This method is not very effective because the capture of odours is too far from the source.

Other methods attempt to eliminate odours by deodorization techniques, but they cause more problems than they offer solutions, and are mostly harmful to the environment and/or health.

As described above, the different known methods, techniques and devices, all have disadvantages making them ineffective.

Several known systems, methods and devices have been put forward to solve the problem of extracting and evacuating odours emanating from the bowls of sanitary wares. These systems, methods and devices are grouped into several categories which are characterized according to their construction and mode of operation.

### Suction Through the Seat and Evacuation Through a Ventilation Line

This category of systems includes for example U.S. Pat. Nos. 4,402,091 (ELLIS) and 3,069,696 (HOWELL), which have the following disadvantages. The partially integrated toilet system with connection to the ventilation line requires major and expensive renovations. The seat must adapt to the shape of the bowl and its piping system may cause health and safety problems.

### Suction by the Seat and Evacuation by the Sewer System

This category of systems includes for example U.S. Pat. No. 4,103,370 (ARNOLD), which has the following disadvantages. The complexity of its piping system may cause health and safety problems. The valve for blocking the return of odours from the sewer is mechanical. This principle of operation does not comply with the plumbing code in North America and does not guarantee a continuous operation without problems.

This category of systems also includes for example U.S. Pat. No. 4,094,023 (SMITH), which has the following disadvantages. The complexity of its piping system may cause health and safety problems. The drainpipe located inside the bowl is extremely problematic for maintenance and can cause major inconvenience when evacuating the droppings. This odour evacuation pipe located in the water trap of the bowl requires an adjustment that is difficult to achieve to be constant in its effectiveness to block the return of odours and does not guarantee continuous operation without problems. In addition, this method of blocking odours by a liquid requires greater water consumption, because the water must be purged from the pipe so that the stale air can be evacuated through the sewers, this loss of water is harmful to the environment.

### Suction Through the Bowl and Evacuation Through a Ventilation Line

This category of systems includes for example Canadian Patent Application No. 3,039,703 A1 (NELSON), international patent application WO2011/153637A1 (LAROUCHE), and U.S. Pat. No. 4,494,255 (DRUMMOND), which have the following disadvantages. These have a partially integrated toilet system requiring a connection to the ventilation line, which requires major and expensive renovations.

### Suction Through the Bowl, and Evacuation Through the Sewer Line

This category of systems includes for example international patent applications WO2017/193194A1 (TRUDEL) and WO2018186541(DECK), U.S. Pat. Nos. 6,983,491 B2 (CURTIS) and 7,275,271 B1 (SMITH), which have the following disadvantages. There is no blockage of the return of odours made by a liquid to guarantee a perfect seal of the return of these from the sewers. The valve for blocking the return of odours from the sewer is mechanical and not passive. This principle of operation does not comply with the plumbing code in North America and does not guarantee a continuous operation without problems.

### Suction Through the Bowl, Evacuation Through the Sewer System, Water Trap

This category of systems includes for example international patent application WO2014/136120A1 (VALAGAM), which has the following disadvantages. This system, which is not integrated inside the tank, is made to be installed downstream of the tank on the rinse line of the bowl because it works by gravity to fill the water trap installed in the piping to evacuate odours. This parallel system of piping installed outside the tank creates a hygiene problem and is conducive to the development of bacteria and viruses that emanate from the toilets. In addition, this non-integrated system requires more space for its installation. This system wastes water because the siphon is emptied and replaced with each use. If the system works over a long period of time, the siphon can empty and no longer prevent the return of odours

This category of systems also includes for example and European Patent Application No. 3553236A1 (LIU) and has the following disadvantages. This system requires a powerful fan to purge water from the U-shaped gasket, which increases the noise level. This system needs a very good sealing of the seal of the lid, because the suction is done at the level of the free space above the water level of the tank. The operation of the system is dependent on the mobile switch (non-passive system) which is operated with the water level of the tank. If any problem occurs with the water level of the tank or the moving switch, then the system no longer works efficiently. There is a waste of water, because the water from the U-shaped gasket is replaced with each use, which has the effect that there is no water permanently in the water trap. The connection of the drainpipe in the upper part of the S of the toilet water trap affects the siphon effect for the evacuation of the droppings to the sewers.

### Suction by the Seat, Evacuation by the Sewer System and Water Trap

This category of systems includes for example U.S. Pat. No. 4,864,664 (HIGGINS) and has the following disadvantages. The seat must adapt to the shape of the bowl and its piping system may cause health and safety problems. The system that is integrated inside the toilet tank is bulky which requires a larger tank to have enough water to ensure its efficient operation. A larger tank is contrary to the modern trend that requires sanitary facilities (toilets) with a reduced physical and ecological footprint to reduce construction costs. This system wastes water because the water trap is emptied and is replaced with each use. If the system works over a long period of time, the water trap can be emptied by evaporation and no longer prevent the return of odours.

### System with Filter and Release to Ambient Air

This category of systems includes for example U.S. Pat. No. 4,317,242 (STAMPER), which has the following disadvantages. The design of these systems that are added to toilets are harmful to the environment because they use filters and often electric batteries for their operation. These inconvenient, unsightly and unsafe systems, require a high level of maintenance and lead to hygiene problems.

In view of the disadvantages and defects associated with the known different systems of the prior art, there is a need for a solution to the existing problems.

### SUMMARY OF THE INVENTION

In order to address the above drawbacks, there is provided a system and device as defined in the claims.

In embodiments, there is provided a fully integrated equipment installed inside a toilet tank for the extraction and evacuation of odours as well as contaminated air that is usually found in a toilet, and continuously guarantees a passive water trap to block the return of odours from the sewer connected to the sanitary appliance.

In embodiments, the system does not add any moving part (except the fan) for the operation of the three main components: the extraction/suction system, the water trap, and the evacuation part of a conventional toilet. A set of electronic controls completes the equipment.

In embodiments, the system maintains a water trap continuously and is not dependent on the displacement or level of the water in the tank. The simplicity of design and operation of the equipment gives it robustness and reliability. The fan is installed and held in place above the water level in the tank. Electrical and electronic components are located outside the sanitary appliance.

In embodiments, sanitary apparatuses of the system include a suction system configured for a toilet with a bowl comprising a ledge with many holes or rinse slots, through which gases and contaminated air can be sucked in, a toilet tank including a flush mechanism, a float valve to fill the tank with water, and an overflow pipe communicating with the flush hole.

In embodiments, the fan, supplied by a low-voltage and electronically controlled electric current source, allows the adjustment of the various parameters of the invention and is installed in the upper part of the tank, above the water level contained therein. This fan is placed near the overflow pipe to draw in the air contained in the bowl through the rinse holes.

In embodiments, once passed through the fan turbine, the gases and contaminated air are directed to the decanter using the suction duct which is connected to the suction part comprising the 180-degree calibrated elbow, and then passes through it and through the expulsion duct that emerges inside the decanter transfer chamber. This decanter is in the upper part of the permanent water retention tank and is immersed by the water from it in its lower part, thus creating a water trap ensuring a perfect seal, which at the same time creates the transfer chamber that allows gases and contaminated air to be evacuated to the sewer network by the toilet exhaust duct.

In embodiments, the decanter with its transfer chamber thus forms a passive water trap perfectly sealed to the return of gases sent by the evacuation system to the sewers. A hole specially calibrated for the filling of water and located on the elbow expulsion pipe calibrated at 180 degrees in the evacuation part, allows the filling and maintenance of the minimum required water level continuously in the water trap, regardless of the water level contained in the tank.

In embodiments, there is provided a system that is fully integrated to a toilet and achieves extraction, evacuation and blocking of the return of odours, as well as many pathogens such as bacteria (Tuberculosis, E Coli, etc.) and viruses (Coronavirus, Flu, etc.) spread by aerosols from the bowls of sanitary ware (e.g. toilet, urinal, bidet, etc.), using a passive and continuous water sealing devices for achieving odour seals.

In embodiments, there is provided a toilet with an integrated odour evacuation system, a sanitary ware which vacuums bad odours, including bacteria and virus, and eliminates them by the sewage pipes.

In embodiments, the system includes an odour suction device comprising a small fan specifically and specially adapted to work silently, non-stop if needed, and in a humid compact environment.

In embodiments, the system is installed in the tank of the toilet. The suction device is powered by a very safe and small (24-Volts, 1 Ampere) adaptor consuming very small amounts of energy.

In embodiments, the system sucks odours directly from the holes of the toilet bowl rim. Then, the unpleasant odours, including bacteria and viruses, are evacuated through the toilet drain (the outlet) and into the sewage pipes with all the droppings. And the odours cannot return because of the passive water trap.

If a septic tank and a purification field installation is present, this additional air will be beneficial and healthy for the bacterial activity in the wastewater treatment system.

In embodiments, users do not need to worry about odours coming back, because the system is sealed by water and complies with the plumber standards “P-Traps.”

In embodiments, there is provided a toilet designed to work with a system, comprising a small fan precisely chosen for its performance, and a designed and calibrated 180-degree elbow, including an expulsion hose with a calibrated hole that allows the air to pass into the transfer chamber of the decanter, then to the sewer pipe for expulsion. When the fan stops, the water from the permanent water retention tank fills the 180-degree calibrated elbow and makes a seal to prevent gas from coming back of the sewage pipe.

In embodiments, the toilet is different from other known toilets because it has an additional part. This part is a new path that has the function to directly connect the system to the outlet of the toilet. The outlet lies on a wax seal applied on the flange screwed on the floor when installing the toilet.

In embodiments, the fan's function is to suck the air (which is full of bad odours, including bacteria and viruses) from the little rim holes of the toilet bowl by using the overflow tube in the tank of the toilet. This piece is connected to the inlet of the toilet tank, that allows water to go into the toilet bowl. The fan also draws air to the designed and calibrated 180-degree elbow.

The calibrated 180-degree elbow function is to take the air brought by the fan and make it pass through an expulsion hose with a calibrated water filing hole to the transfer chamber of the decanter. This will release the air full of bad odours (bacteria & virus included) to the top of the decanter, and then the air will continue its way into the newly created path of the toilet, until it reaches the outlet and the sewage pipe.

In embodiments, the suction part creates a negative pressure at the level of the bowl comprising: the fan, the power supply, electronic control, overflow pipe, suction duct, 180-degree calibrated elbow, the toilet bowl and the flushing holes of it or the bowl of another kind of sanitary ware.

In embodiments, vacuum air and its contents into the bowl and ambient area to send it to the decanter transfer chamber.

In embodiments, the water trap part, which creates a water trap, commonly known as “P-Trap”, and which serves to conserve a part of water to permanently block the return of odours from the sewers, when the suction system is not in operation because of the following components: 180-degree calibrated elbow, an expulsion duct, a calibrated filling hole, permanent water retention tank, a decanter, and a transfer chamber. This guarantees and permanently prevents the return of odours from sewers using a passive water trap.

In embodiments, the evacuation part which uses a decanter to eliminate water loss and create a transfer chamber to ensure the removal of odours as well as air contaminated with different aerosols and which includes: the fan, 180-degree calibrated elbow, expulsion duct, permanent water retention tank, decanter, transfer chamber, toilet drain duct, P-TRAP connection pipe, drainpipe to the sewer.

In use, the evacuation part receives the air and its contents from the lower part of the 180-degree calibrated elbow, pushed by the fan, and then separates the air from the water it can hold. This water, which is separated by the gravitational force when projected on the surface of the decanter, falls by gravity into the lower part of the decanter which is immersed in the permanent water retention tank and thus avoids water losses. The air and its contents, thus separated from the water, pass through the evacuation parts of the system which is installed in the tank and which is connected to the pipe “P-TRAP connection,” to be then directed to the sewer network.

### BRIEF DESCRIPTION OF THE DRAWINGS

FIG. 1 is cross-section view of a system integrated into a full tank, when in function, in accordance with an illustrative embodiment of the present invention.

FIG. 2 is cross-section view of the system shown in FIG. 1, when out of function, in accordance with an illustrative embodiment of the present invention.

FIG. 3 is cross-section view of the system shown in FIG. 1 into an empty tank, when in function, in accordance with an illustrative embodiment of the present invention.

FIG. 4 is cross-section view of the system shown in FIG. 1 into an empty tank, when out of function, in accordance with an illustrative embodiment of the present invention.

FIG. 5 is cross-section view of the system shown in FIG. 1 into an empty tank, when out of function, in accordance with an illustrative embodiment of the present invention.

FIG. 6 is a cross-section view of a first part of the system shown in FIG. 1, in accordance with an illustrative embodiment of the present invention.

FIG. 7 is a cross-section view of a second part of the system shown in FIG. 1, in accordance with an illustrative embodiment of the present invention.

FIG. 8 is a cross-section view of a third part of the system shown in FIG. 1, in accordance with an illustrative embodiment of the present invention.

### LIST OF ELEMENTS

1. Overflow
2. Blower 24V
3. Water intake
4. Suction pipe
5. Permanent water retention tank
6. Calibrated Offset 180°
6a Water trap
7. Flushing
7a. Flush chamber
8. Decanter
8a. Transfer chamber
9. Expulsion pipe
10. Toilet tank
11. Calibrated water filing hole
12. Toilet waste pipe
13. Sealing joint
14. Tightening nut
15. Motion sensor
16. Boost button 10 min.
17. P-trap pipe fitting
18. P-trap connecting ring
19. Sewer
19a. Sewer drain pipe
20. Suction hole and bowl rinsing
21. Toilet bowl
22. Water trap
23. Blower adapter
24. Hollow rim

### DETAILED DESCRIPTION OF THE ILLUSTRATIVE EMBODIMENTS

By way of example only, preferred embodiments of the present invention will now be described with reference to the accompanying drawings which form a part hereof. And by way of illustration, the drawings herein depict specific embodiments by which the invention may be practised.

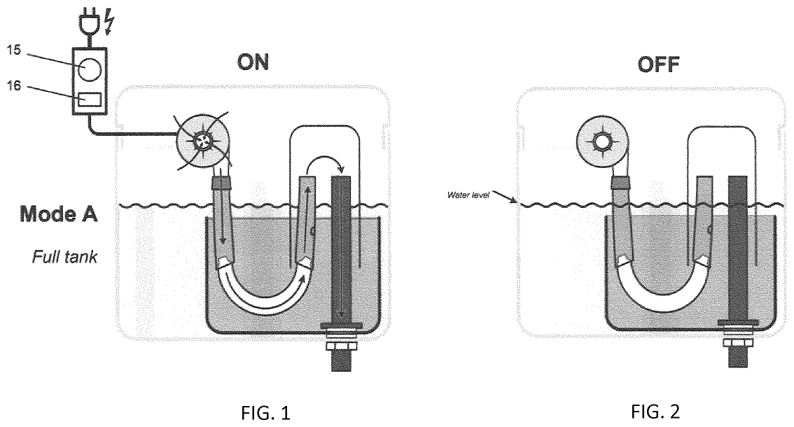

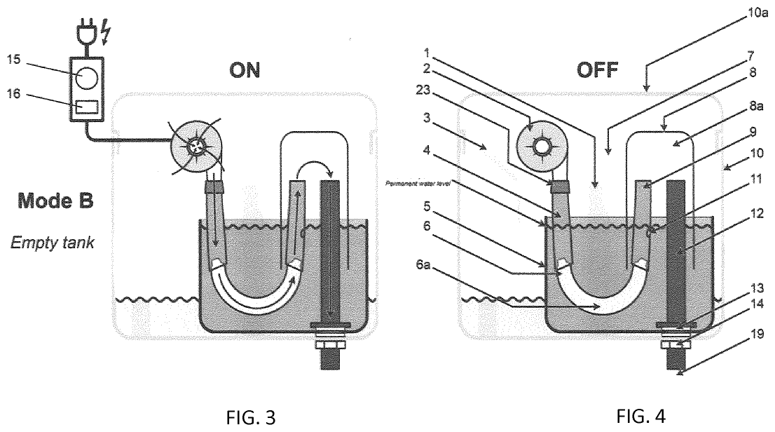

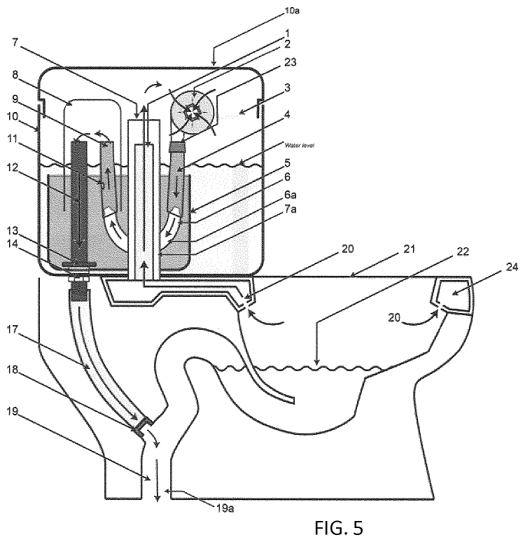

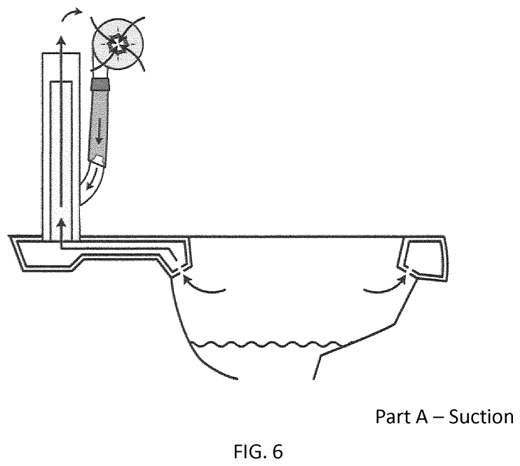

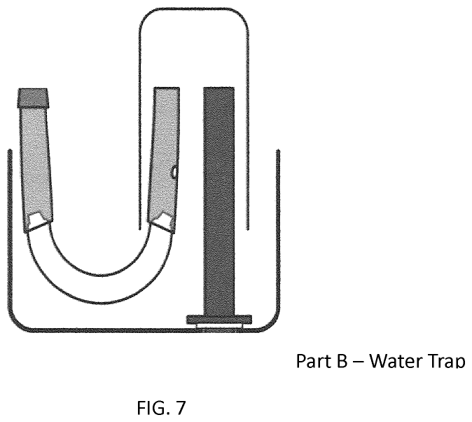

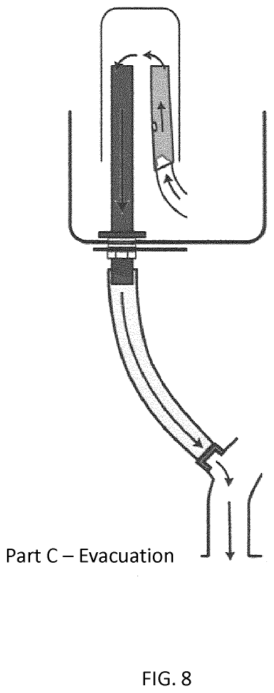

Referring now to FIGS. 1 to 8, a system for use with a toilet, which will be exposed in more detail below, includes three parts that are fully integrated inside the tank of a conventional toilet. The first part or suction part includes a fan 2 supplied by a source of electric current at low voltage (not illustrated) and electronically controlled allowing the adjustment of the various parameters of the system. The fan 2 is positioned above the water level of the tank and installed in the upper part of the system/evacuation/suction module.

Referring back to FIGS. 1 to 6, there is shown a system configured to be used with a conventional toilet, according to a preferred embodiment. The toilet has a toilet bowl 21 that includes a hollowed-out edge or rim 24 having on its perimeter several rinse holes 20 drilled in its lower part. This edge or rim 24 is part of a flush chamber 7a which includes a flush system 7 and a pipe of overflow 1. The bottom of the bowl also includes a water trap 22 which is connected by a drain pipe 19A to the sewer network (not shown).

The tank 10 incorporates the three parts of the system, which are a) a suction part which creates a negative pressure at the bowl 21; b) a water trap which creates a water trap 6a, commonly known as “P-Trap” preventing the return of odours from sewers; and c) an evacuation part which uses a decanter 8 to eliminate water loss and create a transfer chamber 8A to ensure the removal of odours as well as air contaminated with different aerosols.

Referring back to FIGS. 1 to 6, the suction part includes the fan 2 that is powered by a power supply (not illustrated). The fan 2 is connected to electronic controls located outside the toilet tank for controlling operation of the fan 2. The electronic controls may include a motion sensor 15 and boost button 16. The motion sensor 15 is configured to operate the fan 2 automatically when sensing a movement originating for example from a user. The boost button 16 may be depressed by the user to achieve a fan operation for a predetermined time, such as ten minutes. The fan 2 is branched to be in communication to a suction duct 4 and connects to a 180-degree calibrated elbow 6. The fan 2 is located above the water level of the tank, not far from the hose of too full 1 which makes the link with the toilet bowl 21, and the rinsing holes 20 thereof or the bowl of another sanitary appliance, which completes the suction part of the system.

In operation, the suction part uses the fan 2 to create an air vacuum and suck the odour contents of the bowl 21 and ambient area and to send this sucked air to a decanter transfer chamber.

Referring back to FIGS. 1 to 7, the second part or water traps part creates a water trap 6a, commonly known as “P-Trap”, that permanently blocks the return of odours that may come from the sewers when the fan 2 is not in operation. The water part trap includes a suction duct 4 connected to a 180-degree calibrated elbow 6, and to an expulsion pipe 9 including a calibrated filling hole 11. A permanent water retention tank 5, a decanter 8 and a transfer chamber 8A complete the water traps part.

When not in operation, i.e. the fan is off, the water traps part is configured to permanently prevent the return of odours from sewers using a passive water trap.

Referring back to FIGS. 1 to 8, the third part or evacuation part includes a decanter 8 to eliminate water loss and create a transfer chamber 8a to ensure the removal of odours as well as air contaminated with different aerosols. The evacuation part uses the fan 2 to direct the gases and aerosols coming from the bowl 21 through the suction duct 4, through the 180-degree calibrated elbow 6, to the expulsion duct 9 which pushes the gases into the transfer chamber 8a so that they are then evacuated through the exhaust duct of the toilet 12 and the pipe connection P-trap 17 to the sewers 19.

In operation, the evacuation part receives the air and its contents from the lower part of the 180-degree calibrated elbow 6, pushed by the fan 2, and then separates the air from the water it can hold. This water, which is separated by the gravitational force when projected on the surface of the decanter 8, falls by gravity into the lower part of the decanter 8 which is immersed in the permanent water retention tank and thus avoids water losses.

The air and its contents, thus separated from the water, pass through the evacuation parts of the system which is installed in the tank 10 and which is connected to the pipe “P-trap connection,” to be then directed to the sewer network.

According to another preferred embodiment the system is configured to be used with sanitary appliances that do not contain a water tank and that is a direct flush. In this embodiment, the system is integrated into a tamper-proof box that matches the toilet taps. This box contains the present system, the power supply, the electronic controls as well as the start-up system. It is specifically configured for use with sanitary appliances that do not contain a tank and are connected directly to the water supply line. It is incorporated on one side into the supply piping to maintain the water trap. The suction system is connected upstream of the flush valve to the direct flush column that is connected to the flush chamber and the flushing holes of the toilet bowl. The main drainpipe from the centrifugal separator that contains the stale odours and various aerosols is connected downstream of the toilet water trap to remove them through the sewer system.

According to yet another preferred embodiment, the system is configured to be used with home or commercial composting devices. In this embodiment, the system is integrated into a tamper-proof housing that is added, and which is independent of the composting apparatus. This box contains the present system, the power supply, the electronic controls as well as the start-up system. It is specifically configured for use with composting devices that do not have a water supply. It is connected on one side to the supply piping to maintain the water trap. The suction system is connected to the composting chamber that contains the odours, and the main drainpipe from the centrifugal separator that contains the stale odours is connected downstream of the water trap or from the siphon of the piping to be removed by the sewer system.

Advantages of the preferred embodiments:

The system eliminates the costly and sometimes complex need for a ceiling fan installation.

The system eliminates discomfort and embarrassed created by odours during toilet visits.

Passive water traps with no moving parts.

A system fully integrated into the sanitary appliance.

A system that can be incorporated into composting systems.

The system does not change the aesthetics of the sanitary appliance.

Simple, robust and reliable system operating continuously.

An economic system that protects the environment and consumes less energy.

The system increases the quality of life and the level of hygiene.

The system reduces the risk of contagion by bacteria and viruses from aerosols.

The scope of the claims should not be limited by the preferred embodiments set forth in the examples but should be given the broadest interpretation consistent with the description as a whole.

### DEFINITIONS

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Unless otherwise defined, all technical and scientific terms used herein have the same meaning as commonly understood by one of ordinary skill in the art to which this invention belongs.

1. A system for use with a toilet, the system comprising:
a fan (2) in communication with a toilet bowl (21) for evacuating contaminated air from the toilet bowl (21);
a water trap (6a) in communication with the fan (2) for preventing odours from returning from a sewer drain pipe (19a); and
a decanter (8) having an input in communication with the water trap (6a) for preventing water loss and including a transfer chamber (8a) for removal of odours, the decanter (8) having an output in communication with a waste pipe (12) and the sewer drain pipe (19a),
wherein the water trap (6a) and the decanter (8) are partially immersed in a permanent water retention tank (5), and wherein the water trap (6a) comprises a calibrated water filling hole (11) in communication with the permanent water retention tank (5), thereby creating a passive water trap to block the return of gases into the system when the permanent water retention tank (5) is filled with water.

2. The system of claim 1, wherein the toilet is a toilet with a toilet tank (10), and wherein the input of the decanter (8) is in communication with the water trap (6a) for preventing water loss in said toilet tank (10).

3. The system of claim 2, wherein the fan (2) is located within the toilet tank (10) above a water line thereof.

4. The system of claim 1, wherein the toilet is a direct flush tankless toilet.

5. The system of claim 1, wherein the water trap (6a) comprises a calibrated 180 degree elbow (6), wherein one end of the calibrated 180 degree elbow (6) is in communication with the fan (2), and another end of the calibrated 180 degree elbow (6) is in communication with the input of the decanter (8).

6. The system of claim 1, further comprising a proximity detection system integrated into a flush button.

7. The system of claim 1, further comprising a centrifugal separator for water recovery and/or for increasing the efficiency of the water trap.

8. The system of claim 1, wherein the fan (2) is configured to evacuate contaminated air from the toilet bowl (21) through rinsing holes (20) of the toilet bowl (21).

9. A system for use with a composting device, the system comprising:
a fan (2) in communication with a composting chamber for evacuating contaminated air from the composting chamber;
a water trap (6a) in communication with the fan (2) for preventing odours from returning from a sewer drain pipe (19a); and
a decanter (8) having an input in communication with the water trap (6a) for preventing water loss and including a transfer chamber (8a) for removal of odours, the decanter (8) having an output in communication with a waste pipe (12) and the sewer drain pipe (19a),
wherein the water trap (6a) and the decanter (8) are partially immersed in a permanent water retention tank (5), and wherein the water trap (6a) comprises a calibrated water filling hole (11) in communication with the permanent water retention tank (5), thereby creating a passive water trap to block the return of gases into the system when the permanent water retention tank (5) is filled with water.

10. A box for incorporation into a home or commercial composting device, wherein the box comprises the system of claim 9.

11. A box for incorporation into a direct flush tankless toilet, wherein the box comprises a system comprising:
a fan (2) in communication with a toilet bowl (21) for evacuating contaminated air from the toilet bowl (21);
a water trap (6a) in communication with the fan (2) for preventing odours from returning from a sewer drain pipe (19a); and
a decanter (8) having an input in communication with the water trap (6a) for preventing water loss and including a transfer chamber (8a) for removal of odours, the decanter (8) having an output in communication with a waste pipe (12) and the sewer drain pipe (19a),
wherein the water trap (6a) and the decanter (8) are partially immersed in a permanent water retention tank (5), and wherein the water trap (6a) comprises a calibrated water filling hole

(11) in communication with the permanent water retention tank (5), thereby creating a passive water trap to block the return of gases into the system when the permanent water retention tank (5) is filled with water.

12. The box of claim 11, further comprising a proximity detection system integrated into a flush button.

13. The box of claim 11, further comprising a centrifugal separator for water recovery and/or for increasing the efficiency of the water trap.

14. The box of claim 11, wherein the fan (2) is configured to evacuate contaminated air from the toilet bowl (21) through rinsing holes (20) of the toilet bowl (21).
